(19) United States
(12) Patent Application Publication
(10) Pub. No.: US 2026/0307869 A1
(43) Pub. Date: Oct. 8, 2026

(54) LOCKABLE STORAGE APPARATUS AND METHODS OF USE

(71) Applicant: RXGUARDIAN INC., Sacramento, CA (US)

(72) Inventors: Nathan LANGLEY, Sacramento, CA (US); Joseph Simpson, Plumas Lake, CA (US)

(73) Assignee: RXGUARDIAN INC., Sacramento, CA (US)

(21) Appl. No.: 19/481,376

(22) PCT Filed: May 2, 2024
(86) PCT No.: PCT/US2024/027558

§ 371 Date: Nov. 4, 2025

Related U.S. Application Data
(60) Provisional application No. 63/500,195, filed on May 4, 2023.

(51) Int. Cl. B65D 50/06; A61J 1/03; A61J 7/04

(52) U.S. Cl. CPC B65D 50/06; A61J 1/03; A61J 7/04

(57) ABSTRACT

Methods and systems are provided for providing lockable storage devices, such as locking pill holders providing organization and transient storage of medications. The inventive devices and methods of use provide secure storage, and yet facilitate quick access to the contents of the storage devices by a user who is familiar with the operation of those devices. Inventive features provide for increased integrity over known storage devices.

### CROSS-REFERENCE TO RELATED APPLICATIONS

This application claims priority to U.S. Provisional Patent Application No. 63/500,195, filed May 4, 2023, the entire contents of which are incorporated herein by reference.

### TECHNICAL FIELD

Apparatus and methods are provided for lockable storage, which are especially suited for organization and storage of pills or other items for which transient storage and uncomplicated access is desired.

### BACKGROUND

Storage containers are available in a variety of sizes and shapes. Some of these known devices include medication organizers, in which a user may move prescription or non-prescription medication from its packaging and sort pills based on dosage. Some of these devices include seven individual compartments to store weekly medication separated into daily dosages. Other medication organizers may include 14 individual compartments, allowing the storage of weekly medication to be separated into morning and evening doses. Other configurations exist, as well. Of course, such storage containers need not be limited to use for storing medication, but may be useful for storing other items, such as earrings, candy, and other appropriately-sized sundries.

To prevent unintended opening of a storage container, it is desirable to provide a closure system that locks into place. The desire to maintain the security of the storage container is balanced by a desire to provide a way to unlock the container without undue force or complicated steps, such that it could be performed by someone with arthritis or other limitations of their dexterity.

While medication organizers are known and readily available, existing systems suffer from a variety of disadvantages. For example, U.S. Patent Application Publication 2005/0218031 discloses a pill organizer having compartments for holding medication divided into doses for a seven-day period, wherein the compartments include hinged lids. Such devices suffer from a lack of a secure closing system and may open on undesired occasions. For example, such devices, when placed in a purse or in a carry-on bag when traveling, may open due to an application of force to the underside of a tip of a lid, causing the medication to be spilled out.

Other known storage systems include lids that slide. For example, U.S. Patent Application Publication 2016/0297580 discloses a storage system having a slidable lid. Devices disclosed in that application include configurations that may cause a user to be pinched when returning an open lid to the closed position. Additionally, when a lid of such systems is open, it is subject to dislocation if exposed to an oblique force, which may affect the operability of the lid.

Accordingly, there is a need in the art to provide lockable storage apparatus and methods of use that provide secure containment of items, yet permits a user with limited dexterity to open the apparatus and access the items within.

There is a further need in the art to provide lockable storage apparatus and methods of use that prevent unintended opening, such as due to a force applied to the underside of the tip of a closure lid.

There is yet a further need in the art to provide lockable storage apparatus and methods of use that reduce the potential of user harm from pinching or other mechanical interference when operating the apparatus.

There is also a need in the art to provide lockable storage apparatus and methods of use that reduce the likelihood of inoperability due to an oblique force to an open lid.

### SUMMARY

In accordance with the principles of the present invention, lockable storage apparatus and methods of use are provided that overcome the disadvantages of the previously known storage systems. Specifically, devices constructed in accordance with the present invention provide secure containments of items, while permitting access by users with limited dexterity. Devices constructed in accordance with the present invention further prevent unintended opening, reduce the potential for user harm, and reduce the likelihood of inoperability due to an oblique force to an open lid.

In accordance with one aspect of the invention, a lockable container for holding pills comprises a housing defining a plurality of wells, each well of the plurality of wells comprising a guide. These embodiments also comprise a plurality of lids, each lid of the plurality of lids configured to lock a corresponding well of the plurality of wells in a closed position, each lid comprising a slidable base and a cantilever extending from a top surface of the slidable base, wherein a free end of each cantilever comprises a protrusion extending therefrom, the lid is configured to be slidably coupled to a corresponding guide, and the slidable base comprises a receiver. In these embodiments, the cantilever is configured to move between a first position and a second position in response to application of an opening force such that the protrusion moves into the receiver to unlock the lid and permit the slidable base to slide relative to the corresponding well, to thereby open the corresponding well.

In some of these embodiments, each lid of the plurality of lids further comprises a bottom surface, the bottom surface comprising a stopping member, and each bottom surface may also comprise a lower extension defining the corresponding receiver. Moreover, each lower extension may comprise a front surface, the front surface extending beyond the housing when the corresponding lid is in the closed position. In some embodiments, each protrusion is configured to engage the housing when the corresponding cantilever is in the first position. The housing of some embodiments further comprises a crossbar configured to prevent the lid from sliding along the corresponding guide when the cantilever is in the first position, and in some of these embodiments, the cantilever is configured to slide under the crossbar when the cantilever is in the second position to permit the lid to be unlocked to open the corresponding well. In some embodiments, engagement between the protrusion and the housing causes an audible sound when the lid is transitioned to the closed position to indicate that the lid is locked. And in some embodiments, each slidable base comprises a front surface, the front surface extending beyond the housing when the corresponding lid is in the closed position.

In accordance with another aspect of the invention, a lockable container comprises: a housing defining a well, the well comprising a guide; a lid configured to lock the well in a closed position, the lid comprising a slidable base and a cantilever extending from a top surface of the slidable base, wherein a free end of the cantilever comprises a protrusion extending therefrom, the lid is configured to be slidably coupled to the guide, and the slidable base comprises a receiver, wherein the cantilever is configured to move between a first position and a second position in response to application of an opening force such that the protrusion moves into the receiver to unlock the lid and permit the slidable base to slide relative to the well, to thereby open the well.

In some of these embodiments, the lid further comprises a bottom surface, the bottom surface comprising a stopping member, and the protrusion may be configured to engage the housing when the cantilever is in the first position and/or the housing may further comprise a crossbar configured to prevent the lid from sliding along the guide when the cantilever is in the first position. In some of these latter embodiments, the cantilever is configured to slide under the crossbar when the cantilever is in the second position to permit the lid to be unlocked to open the well. In some embodiments, engagement between the protrusion and the housing causes an audible sound when the lid is transitioned to the closed position to indicate that the lid is locked. In some embodiments, the bottom surface further comprises a lower extension defining the receiver. And in some embodiments, the lower extension comprises a front surface, the front surface extending beyond the housing when the lid is in the closed position.

In accordance with yet another aspect of the invention, methods of operating apparatus are provided. In some embodiments, a device such as one of the apparatus described above is provided. Assembly of the device is achieved by coupling each lid with its corresponding guide and sliding the lid over the well until the cantilever moves to the first position.

In some embodiments, methods of using apparatus are provided. Apparatus, such as described above, are provided. A user desiring to access a well may open the lid by applying a force to the cantilever sufficient to move the cantilever from the first position to the second position. The user then applies a sliding force on the lid directed toward the free end of the cantilever sufficient to cause the lid to slide relative to the guide, thereby providing access to the corresponding well.

One of skill in the art will appreciate that these and other advantages may be attained by the invention disclosed herein.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; emphasis instead is placed on illustrating the principles of the inventive concepts. Also, in the drawings, like reference characters may refer to the same parts or similar parts throughout the different views. It is intended that the embodiments and figures disclosed herein are to be considered illustrative rather than limiting.

FIG. 1 is a perspective view of an exemplary lockable storage device in accordance with principles of the present invention;

FIG. 2 is a perspective view of an exemplary lockable storage device in accordance with principles of the present invention;

FIG. 3 is a perspective view of an exemplary lockable storage device in accordance with principles of the present invention;

FIG. 4A is a top view of an exemplary lockable storage device in accordance with principles of the present invention;

FIGS. 4B, 4C, and 4D are, respectively, cross sectional views of a locked well, an unlocked well, and an open well of the exemplary lockable storage device of FIG. 4A;

FIG. 5 is a front view of an exemplary lockable storage device in accordance with principles of the present invention;

FIGS. 6A-6G are, respectively, perspective, top, side, front, side, perspective, and bottom views of an exemplary lid for a lockable storage device in accordance with principles of the present invention;

FIG. 7 is a flow chart for assembling a lockable storage device in accordance with principles of the present invention; and

FIG. 8 is a flow chart for using a lockable storage device in accordance with principles of the present invention.

### DETAILED DESCRIPTION

The present invention is directed to devices, systems and methods for providing lockable storage, and is applicable to the transient storage and organization of loose items. More particularly, the inventive systems and methods enable medications to be moved from their original containers and stored in one or more groups based on dosage. Applications of the inventive system and methods include organizing a number of different medications into daily groupings that include the desired dosage of each of the different medications. Such designs provide a convenient way to transport medication in a secure locked container that is extremely resistant to inadvertent opening while being jostled in a purse or a backpack.

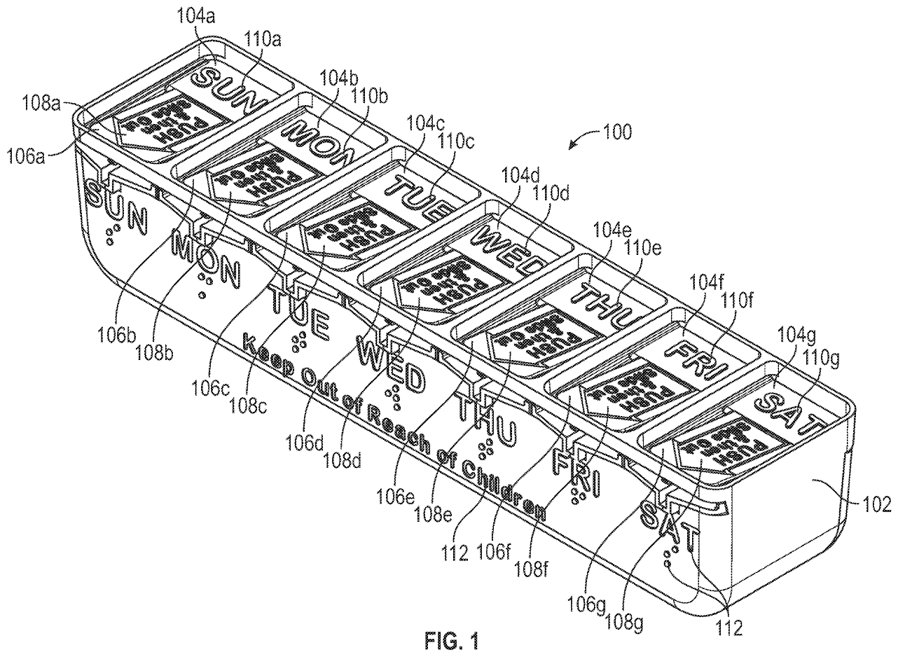

Referring to FIG. 1, an exemplary lockable storage device in accordance with principles of the present invention is described. Storage device 100 illustratively is provided with seven separate storage compartments in order to organize and separately retain medication or other items for convenient daily access. Storage device 100 includes housing 102 that defines portions of the storage compartments. Specifically, the storage compartments include wells defined by housing 102 and which may be accessed by opening slidable lids 104. In the embodiment of FIG. 1, storage device 100 includes lids 104a-104g, each of which corresponds to a separate storage compartment. Each lid 104 includes cantilever 106 that may be manipulated by a user in the process of opening the respective storage compartment, explained in greater detail below.

In some embodiments, lids 104 include cantilever markings 108 on cantilevers 106. For example, lid 104e includes cantilever markings 108e on cantilever 106e including text and graphics of an arrow that provide instructions for unlocking and opening lid 104e. Other optional markings on storage device 100 include lid markings 110, which may indicate the content of the respective storage container or may convey other information, such as a day to open the storage container and access the contents. This latter example is described in reference to FIG. 1 through lid markings 110a-g that correspond to the seven days of the week.

In some embodiments, markings are provided on housing 102. Housing markings 112 may include warnings, information pertaining to the contents of the storage containers, graphics, Braille, or other tactile or texturized surface conditions. In some preferred embodiments, lid markings 110 correspond to housing markings 112, thereby designating a specified order of lid placement relative to housing 102. Such an order may correspond to days of a week (as depicted in FIG. 1) or other desired order. In some embodiments, lids 104 are interchangeable and may be provided with different lid markings 110 and/or colors such that a user may select her own desired order of lids 104 relative to housing 102.

It will be appreciated that other configurations of storage devices in accordance with principles of the present inventions may be provided. For example, a storage device may be provided having more or fewer storage containers than storage device 100, including just a single storage container or 14 or more storage containers.

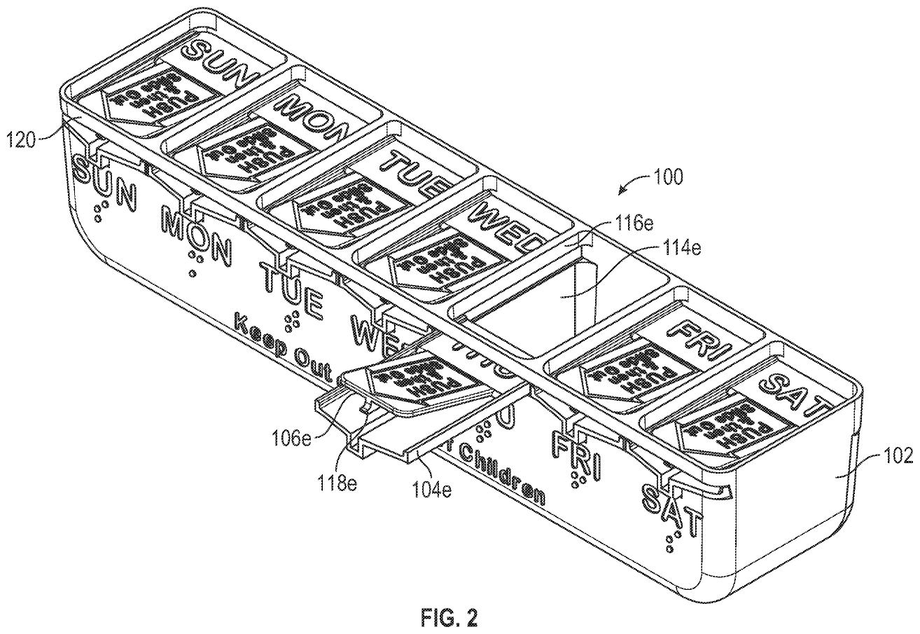

Storage device 100 is further described in reference to FIG. 2. As compared to FIG. 1, lid 104e has been moved to a position in which a storage container is open, revealing well 114e. In this regard, lid 104e is slidably engaged with guide 116e, which in some embodiments is a groove, a rail, or a track, and this interaction between guide 116e and lid 104e assists in maintaining the proper alignment of lid 104e as it transitions between open and closed configurations. Additionally, cantilever 106e includes protrusion 118e that is configured to engage with crossbar 120 of housing 102 when lid 104e is in a closed position.

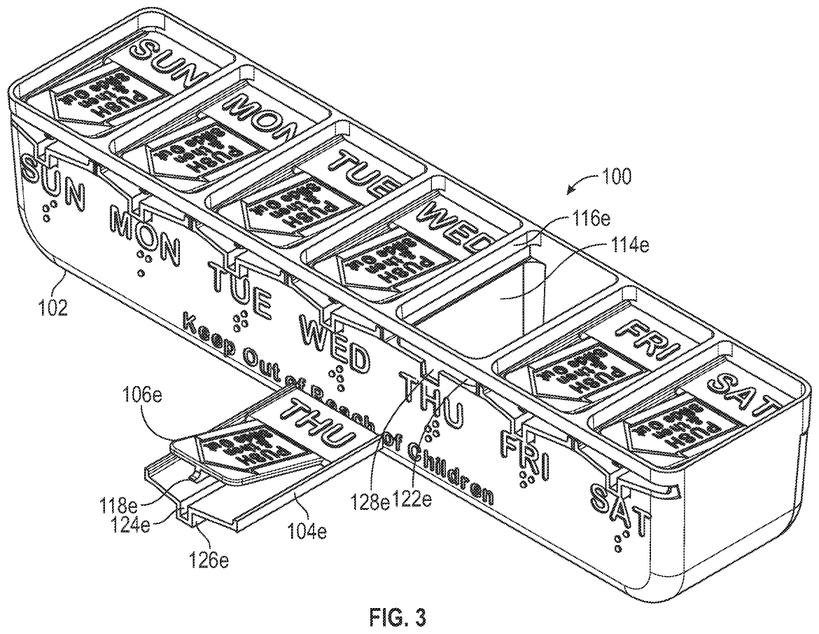

Storage device 100 is yet further described in reference to FIG. 3, depicting lid 104e detached from housing 102. It will be appreciated that lid 104e is sized to be received within opening 122e of housing 102. Further attributes of lid 104e include receiver 124e which is sized and positioned to accommodate protrusion 118e when sufficient force is applied to cantilever 106e to deflect cantilever 106e downward. A bottom surface of receiver 124e is defined by lower extension 126e, which extends downward from the bottom of lid 104e. To accommodate lower extension 126c, opening 122c includes notch 128c.

It will be appreciated that as lid 104e is coupled to housing 102, the interaction of lower extension 126e and notch 128e provides an additional area of interaction between lid 104e and housing 102. Advantageously, if lid 104e is bumped or jostled, the interaction between lower extension 126e and housing 102 via notch 128e provides additional support and reduces the likelihood that the operability of storage device 100 would be adversely affected due to lid 104e being dislocated.

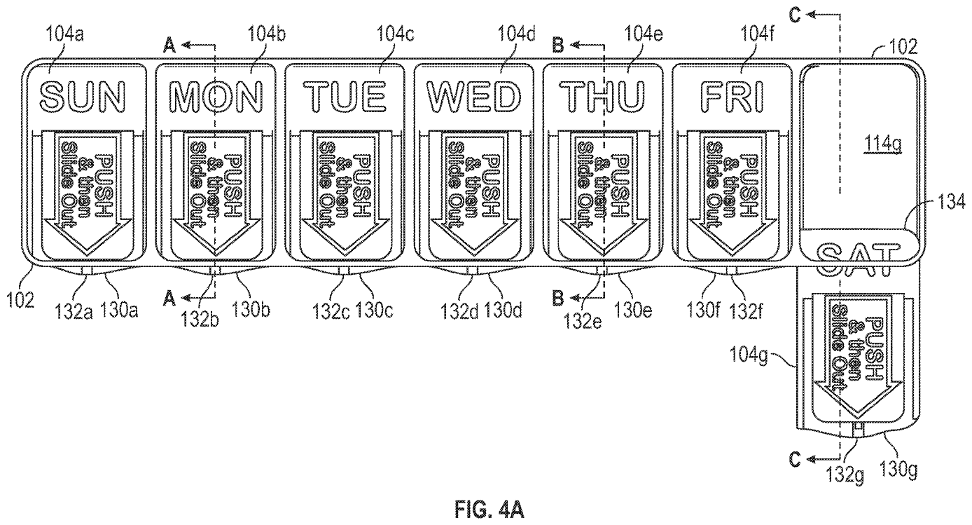

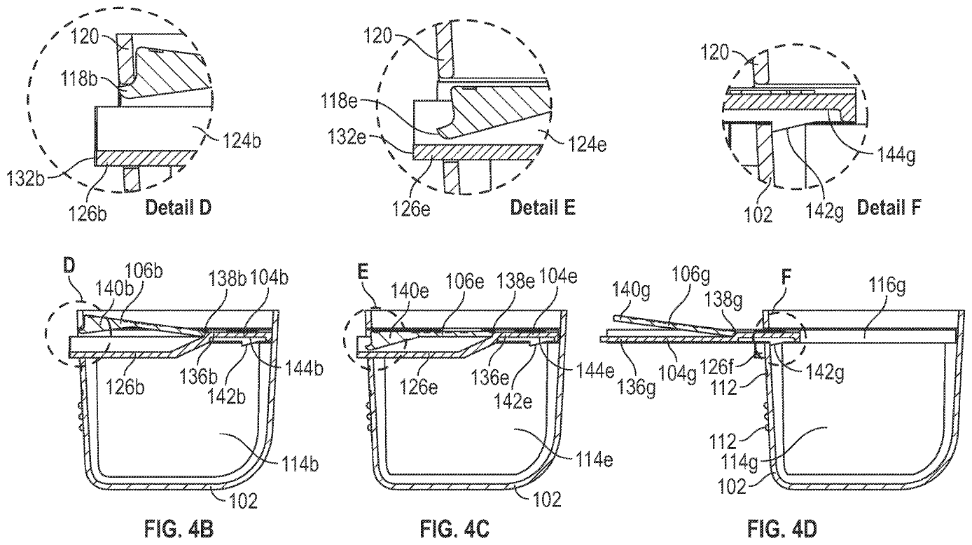

Additional features of storage device 100 are described in reference to FIGS. 4A-D. A top view of storage device 100 is described in reference to FIG. 4A, in which lid 104g is in an open position. When lids 104 are in a closed position, front surfaces 130 of lids 104 and front surfaces 132 of lower extensions 126 extend beyond openings 122. Having front surfaces 130 or front surfaces 132 extend beyond openings 122 has been found to be advantageous over other sliding lid designs because it reduces the likelihood of pinching a user's finger when closing the lid. Other designs having a lid's front surface flush with the front of an opening to accommodate the lid have resulted in the unintended and undesired pinching of a user's finger as the lid is closed. In the design of storage device 100, this problem is overcome by providing an offset between the user's finger and opening 122 as lid 104 is moved into a fully closed position.

Another feature is contour 134 of lid 104g. It will be appreciated that the configuration and shape of each lid 104 may vary. For example, lid 104g is associated with a storage container having corners that are more rounded than those associated with lids 104b-104g. Accordingly, lid 104g includes contour 134 corresponding to the inner surface of well 114g to provide a more secure fit when closed.

Further features of storage device 100 are described in reference to cross-sections of storage device 100 taken along sections A-A, B-B, and C-C, which correspond to storage containers in which lid 104 is closed and locked, is closed and unlocked, and is open, respectively.

The position of cantilever 106 affects whether lid 104 is locked or unlocked. Cantilever 106 is coupled to slidable base 136 of lid 104 at hinge 138. In some embodiments, lid 104 is formed of a single piece of plastic or other polymer. In other embodiments, cantilever 106 is attached to lid 104 at a rotatable joint. In preferred embodiments, lid 104 is biased in an open position wherein free end 140 of cantilever 106 is disposed away from slidable base 136. In embodiments in which lid 104 is constructed of a single piece of plastic, cantilever 106 may be molded such that it remains open in a resting position. In embodiments in which cantilever 106 is attached to slidable base 136 at a rotatable joint, cantilever 106 may be biased in an open position by a spring or other device that can apply a separating force between cantilever 106 and slidable base 136.

FIG. 4B depicts section A-A of FIG. 4A taken through lid 104b which is closed and locked above well 114b. Cantilever 106b is in the resting position, in which it is biased open. As described in reference to Detail D of FIG. 4B, protrusion 118b at free end 140b of cantilever 106b is in contact with crossbar 120. It will be appreciated that a portion of free end 140b is positioned to interfere with crossbar 120 if there is an attempt to slide lid 104b toward an open position without first moving cantilever 106b. As such, lid 104b is in a locked position due in part to this interference. It is further noted that in preferred embodiments, protrusion 118b is located above receiver 124b and that cantilever 106b is sufficiently biased in an open position such that protrusion 118b applies a force to crossbar 120 when lid 104b is in the locked position.

FIG. 4C depicts section B-B of FIG. 4A taken through lid 104e which is closed and unlocked above well 114e. Here, cantilever 106e has moved from the biased open position to a closed position due to the application of force directing free end 140e of cantilever 106e toward slidable base 136e. In this embodiment and configuration, protrusion 118e is disposed in receiver 124e and free end 140e has moved sufficiently so as not to interfere with crossbar 120 and prevent lid 104e from sliding open. It will be appreciated that as force is applied to cantilever 106e, guide 116e provides support to slidable base 136e of lid 104e to resist movement of lid 104e into well 114e.

As described to Detail E of FIG. 4C, it will also be appreciated that in this embodiment, protrusion 118e is set back from front surface 132e. As such, there is a reduced likelihood that movement of protrusion 118e into receiver 124b is not inadvertently impeded by mechanical interference with objects in front of storage device 100. It will be further appreciated that in this preferred embodiment, protrusion 118e is not forced into contact with lower extension 126c when lid 104c is unlocked and cantilever 106c is in a closed position. By avoiding contact between protrusion 118e and lower extension 126e when unlocking lid 104e, there is a reduced risk that protrusion 118e will be damaged due to repeated compression forces.

FIG. 4D depicts section C-C of FIG. 4A taken through lid 104g which is open and unlocked, corresponding to well 114g being open. As described to Detail F of FIG. 4D, stopping member 142g is located on lid 104g. It will be appreciated that although stopping member 142g is located on bottom surface 144g of lid 104g in this embodiment, stopping member 142g could be located elsewhere on lid 104g in other embodiments, such as on cantilever 106g or at another location on top surface of lid 104g.

As lid 104g is moved along guide 116g from a closed position into an open position, stopping member 142g contacts housing 102 to restrict further travel of lid 104g along guide 116g. In preferred embodiments, each lid 104 includes one or more stopping members 142.

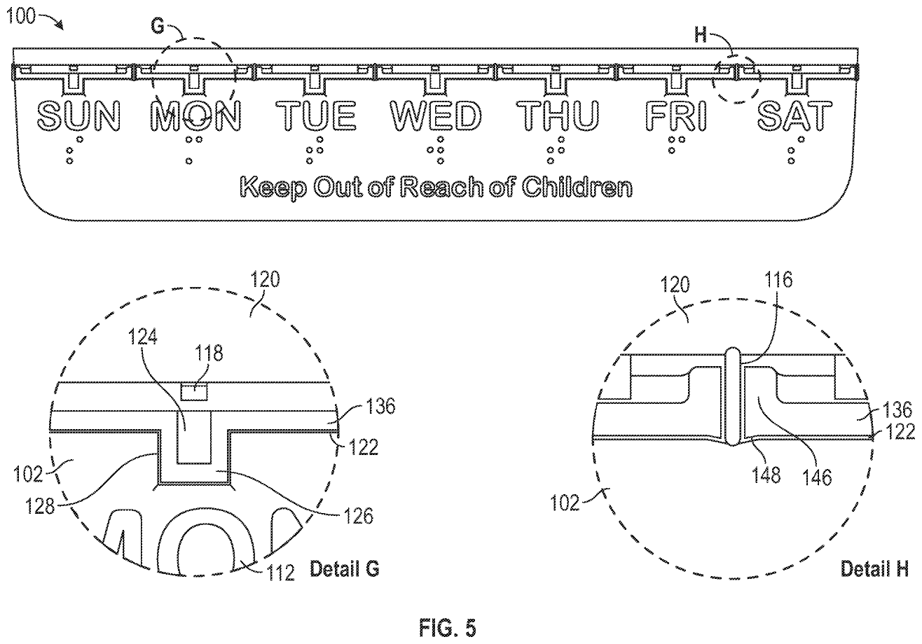

Storage device 100 is further described in reference to FIG. 5, which depicts a front view of an embodiment of storage device 100. As described in reference to Detail G of FIG. 5, in a representative storage container wherein lid 104 is positioned in opening 122 and is in a closed and locked position, protrusion 118 is in contact with crossbar 120. Additionally, opening 122 and notch 128 are configured such that there is limited clearance between lower extension 126 and slidable base 136 on one hand and housing 102 on the other. This configuration enables lower extension 126 to contact housing 102 in the event lid 104 is exposed to an oblique force when not in a fully closed position, and thereby provides additional stability preventing lid 104 from being misaligned.

As described in reference to Detail H of FIG. 5, further stability between lid 104 and housing 102 is achieved by providing slidable base 136 of lid 104 with optional siderail 146 configured to be slidably coupled with guide 116. Slidable base 136 may further include optional flare 148, wherein opening 122 widens at guide 116 to accommodate flare 148. It will be appreciated by those of skill in the art that further stability between lid 104 and housing 102 is provided through these features.

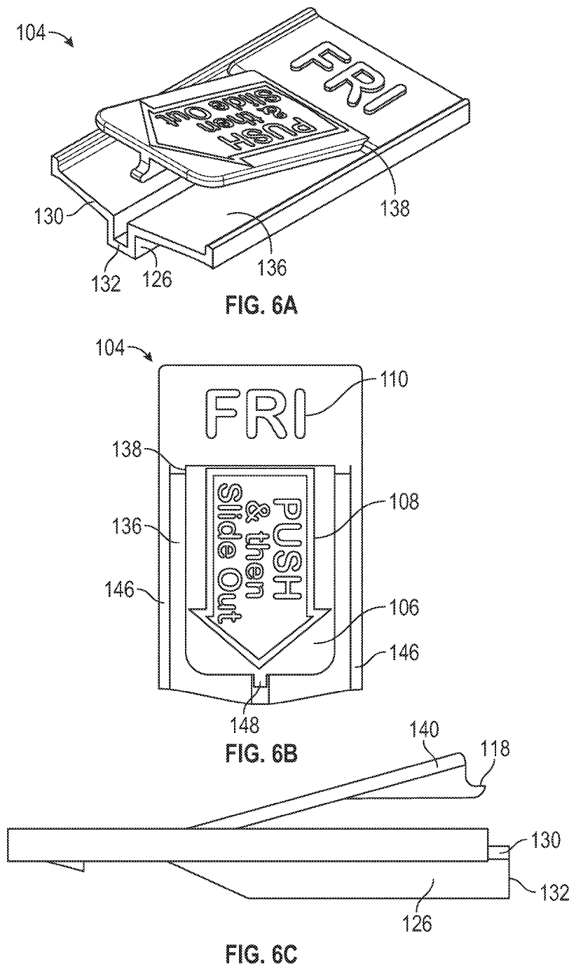

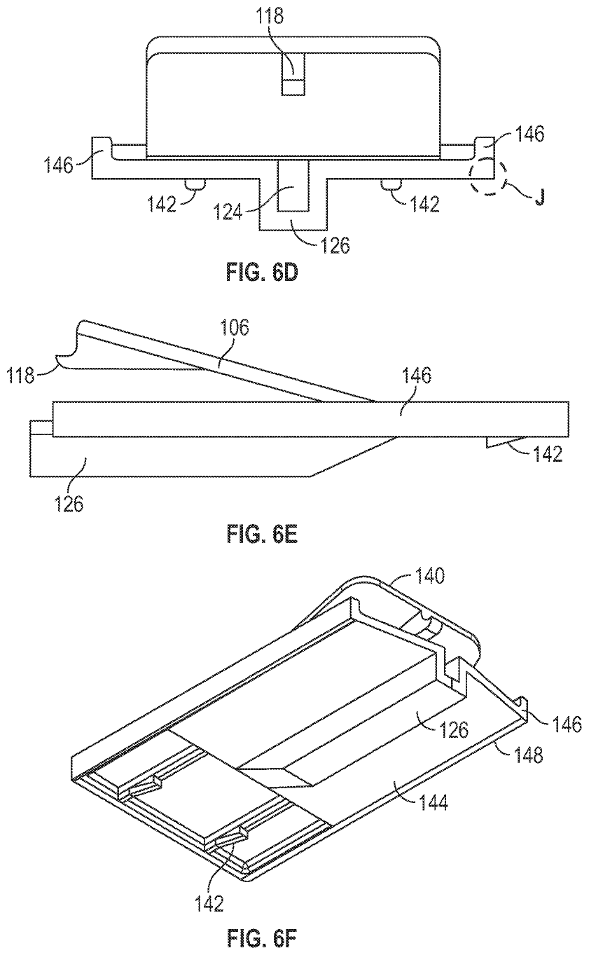

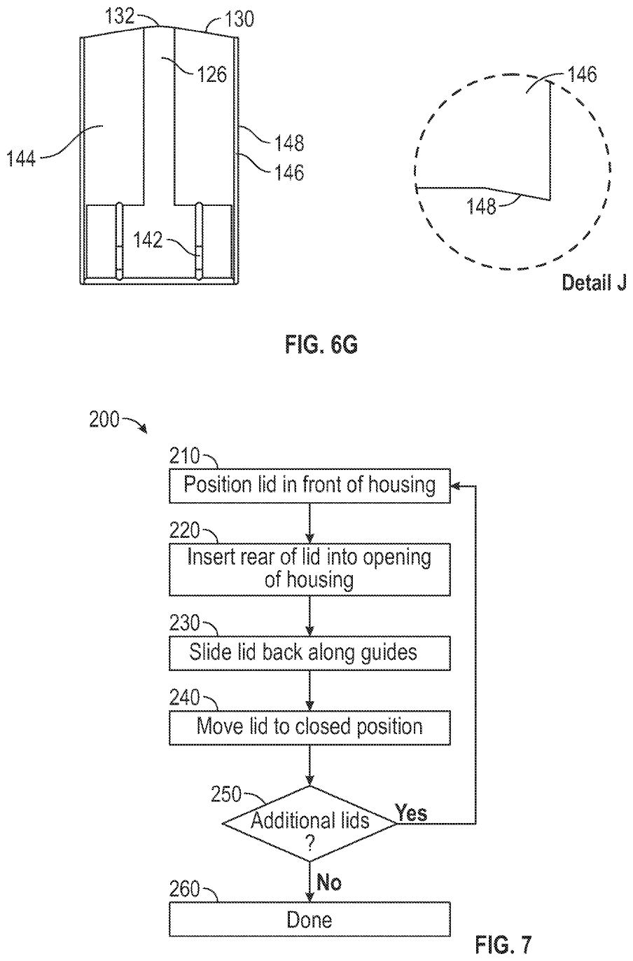

Further description of features of exemplary lid 104 is described with respect to FIGS. 6A-G, which depict a perspective rendering, top view, side view, front view, side view, perspective rendering, and bottom view of lid 104, respectively. In this embodiment, lid 104 includes lid markings 110 identifying a day of the week and corresponding to housing markings 112 (not shown) designating placement at a specified storage container.

Cantilever 106 includes cantilever markings 108, which in this example correspond to instructions to open a corresponding well. Protrusion 118, having a hooked shape in this embodiment, is disposed at free end 140 of cantilever 106. Opposite free end 140, cantilever is attached to slidable base 136 via hinge 138, which in this embodiment is flexible plastic joining cantilever 106 to slidable base 136, wherein hinge 138 is configured to dispose cantilever 106 in an open position absent an application of outside force. As such, cantilever 106 is configured to return to an open position following the removal of an outside force applied to the cantilever. Cantilever 106 may be displaced downward toward slidable base 136 due to the application of a downward force to cantilever, and this displacement may continue until the underside of cantilever 106 contacts an upper surface of slidable base 136. This contact between cantilever 106 and slidable base 136 prevents protrusion 118 from continuing to be displaced sufficiently to contact lower extension 126. As such, in the closed position protrusion 118 is located in receiver 124.

Each siderail 146 is disposed on one of the sides of slidable base 136 and includes flare 148. Each siderail 146 is configured to be slidably engaged with housing 102 via guide 116. Flare 148 extends below bottom surface 144 of lid 104. Preferably, siderails 146 of lid 104 are parallel to one another.

Lid 104 further includes two stopping members 142, each of which extends below bottom surface 144 of lid 104. In this embodiment, stopping members 142 include a flat surface configured to contact housing 102 and an angled surface configured to facilitate attachment of lid 104 to housing 102, as discussed in greater detail below.

In embodiments omitting lower extension 126, receiver 124 is open to the corresponding well. While this may provide the convenience of maintaining receiver 124 clear of dirt or debris that could impede the path of protrusion 118 into receiver 124, such embodiments may allow the dirt or debris to enter the well and contaminate the contents of the well.

Lower extension 126 advantageously provides a physical barrier between the opening of receiver 124 and the well of a storage container. Also, it will be appreciated that if dirt or debris enters receiver 124, such dirt and debris may be easily removed due to the channel-shaped receiver 124 defined by lower extension, which facilitates simplified cleaning by simply tipping the front of lid 104 downward. Additionally, lower extension 126 includes an angled surface that reduces the potential interference between lid 104 and housing 102 when closing lid. It will be appreciated bottom of receiver 124 and at least portions of two sides of receiver 124 are defined by lower extension 126.

In preferred embodiments, front surface 132 of lower extension 126 provides a smooth transition to front surface 130 of slidable base 136 in order to provide an ergonomic surface for a user to push when closing lid 104. As illustrated in FIGS. 6A-G, one example of such a smooth transition includes a protruding curved surface.

The protruding curved surface of lids 104 also provide ease of use of the device. It will be appreciated that in embodiments of storage device 100 having multiple storage containers, a user may ascertain that all lids 104 are in a locked position by sliding the user's finger along the front surface of each lid in a single movement beginning at one end of storage device 100 and ending at the other end.

In preferred embodiments, housing 102 and lids 104 are constructed from plastic or other polymer material. Storage device 100 may be constructed with material that is clear, translucent, or opaque based on the desirability for users (or others) to visually perceive the contents of well(s) 114.

Referring now to FIG. 7, methods 200 of assembling a storage device in accordance with the present invention are described. Assembly of storage devices in accordance with the present invention may be desirable by manufacturers or users of the storage devices. For example, in embodiments having interchangeable lids, a user may wish to remove one lid and replace it with another having different colors or markings. Likewise, a manufacturer may wish to assemble the housing and lid(s) of a storage device in accordance with the present invention prior to selling to the user.

Method 200 begins with one or more lids 104 separate from housing 102. At step 210, a lid 104 is positioned in front of housing 102 such that the rear of lid 104 is capable of being moved into opening 122 of housing 102. Lid 104 and housing 102 preferably share orientations, such that the front surface of housing 102 faces substantially the same direction as front surface 130 of lid 104.

At step 220, the rear surface of lid 104 is inserted into opening 122. Lid 104 is coupled to guides 116. More preferably, optional siderails 146 and flares 148 are coupled with guides 116. Once a cross section of lid 104 is within opening 122, lid 104 is further inserted into opening 122.

Once lid 104 is coupled to guides 116, lid 104 is slidably inserted into housing 102 at step 230, such as through an application of force on front surface 130 or front surface 132, for example. As optional stopping members 142 contact housing 102, additional force may be applied that is sufficient to continue inserting lid 104 into housing 102. In this regard, an angled surface on stopping members 142 will facilitate a smoother insertion of lid 104 into housing. It will be appreciated that once inserted beyond the stopping members 142, flat surfaces on the front of stopping members 142 will oppose the opening of lid 104 once stopping members 142 contact housing 102. In this regard, stopping members 142 facilitate one-way assembly of lid 104 vis-à-vis housing 102 in that stopping members facilitate the insertion of lid 104 during assembly but oppose removal of lid 104 during normal operation of storage device 100.

As lower extension 126 is inserted into notch 128, stability of lid 104 is increased and the interaction between lower extension 126 and notch 128 results in a reduced likelihood that lid 104 would be displaced in the event of exposure to an oblique force, such as if lid 104 was accidently bumped during closure.

Assembly continues at step 240 as lid 104 continues to be inserted into opening 122 until the storage container is closed, such as when well 114 is closed by lid 104. Notably, because cantilever 106 is disposed in an open (locked) position in a resting state, cantilever 106 is forced into a closed (unlocked) position as lid 104 is inserted into opening 122. Once cantilever 106 has passed through opening 122, it may return to its unbiased open position. In preferred embodiments, the natural bias for cantilever 106 to return to its open position is sufficient that protrusion 118 contacts crossbar 120 with sufficient force to create a noise. This noise may present the manufacturer or a user with an audible alert confirming that lid 104 is in a locked configuration.

One lid 104 is inserted into housing 102, step 250 considers whether further assembly is desired with one or more additional lids 104. If so, the method returns to step 210. If no more additional lid assembly is required, the method proceeds to end step 260.

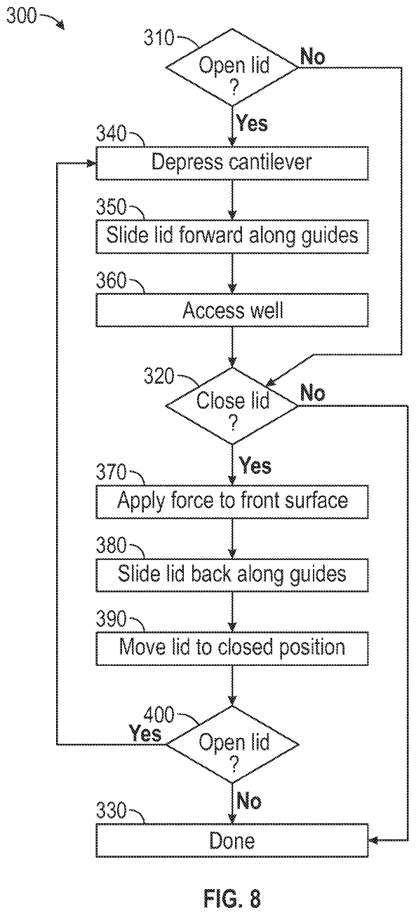

Methods 300 of using storage device 100 are described in reference to FIG. 8. At step 310, a user has the option of whether it is desired to open lid 104, such as to provide access to well 114. If the user does not desire to open a lid, method 300 proceeds to step 320, where the user may choose whether to close a lid 104 at step 320. If the user does not desire to close a lid at step 320, method 300 proceeds to end step 330.

Returning to step 310, if the user does desire to open a lid, method 300 proceeds to step 340, where the user causes a downward force to be applied to cantilever 106. As downward force is applied to cantilever 106, protrusion 118 loses contact with crossbar 120. Continued application of downward force to cantilever 106 causes protrusion 118 to continue downward and into receiver 124. In some preferred embodiments, downward motion of cantilever 106 is discontinued when the bottom surface of cantilever 106 contacts an upper surface of slidable base 136, which preferably occurs prior to contact between protrusion 118 and lower extension 126 or other component.

At step 350, a forward force is applied to lid 104 sufficient to cause lid 104 to slide forward on guides 116 relative to housing 102. In preferred embodiments, this forward force is applied once cantilever 106 has been sufficiently deflected downward such that protrusion 118 does not prevent forward movement of lid 104. Once free end 140 of cantilever 106 has moved forward into opening 122, interference between crossbar 120 and the upper surface of cantilever 106 may prevent cantilever 106 from returning to its unbiased open position. Accordingly, a user may discontinue applying a downward force to cantilever 106 without having cantilever 106 return to an open position and lock the storage container.

At step 350, once protrusion 118 has advanced forward beyond crossbar 120, the user may have limited access to well 114 and may add or remove pills or other items from well 114. Advantageously, due to the position of lower extension 126 relative to notch 128, it will be appreciated that there is increased stability of lid 104 and reduced likelihood that lid 104 would be displaced in the event of exposure to an oblique force, such as if lid 104 was accidently bumped.

It will be appreciated that increased access to well 114 may be desired, which is achieved by further advancing lid 104 forward along guides 116 relative to housing 102. In preferred operating conditions (for instance, when accessing well 114 but not attempting to remove or replace lid 104), lid 104 may be slidably moved along guides 116 until stopping members 142 contact housing 102, thereby impeding further opening motion of lid 104.

At step 360, the user may access well 114, which may occur at any time once lid 104 has been sufficiently opened pursuant to step 350. It will be appreciated that lid 104 may be desired to be opened to various degrees depending on the intent of the user. For example, when adding pills or other items to well 114, a user may find it desirable to fully open lid 104 to the point stopping members 142 contact housing 102. On the other hand, a user desiring to remove items from well 114 may find it more desirable to only partially lid 104 to a point sufficient to where the contents of well 114 may be accessed by rotating storage device 100 backward and tipping contents of well 114 into the user's hand.

Once the user has provided access to the inside of the storage container, the user may choose whether to close the lid. Step 320 provides the user with the question of whether the user wishes to close a lid of the storage device. If the user does not wish to do so, the method proceeds to end step 330. If, instead, a user at step 320 wishes to close lid 104, method 330 proceeds to step 370.

At step 370, the user applies a rearward force to lid 104. In preferred embodiments, the rearward force may be applied by a user's finger to front surface 130 of lid 104 or to front surface 132 of lower extension 126.

At step 380, rearward force is applied to lid 104 sufficient to cause lid 104 to slide through opening 122 along guides 116. In some methods, a user may desire to place cantilever 106 in a closed position, such as by pinching cantilever 106 and slidable base 136 together, prior to or concurrent with the application of the rearward force in order to reduce the amount of rearward force required to close lid 104. Absent such action, as lid 104 slides along guides 116 into housing 102, interaction between crossbar 120 and cantilever 106 causes cantilever 106 to transition from a resting open position toward a closed position.

As lower extension 126 moves into notch 128, the proximity of lower extension 126 to housing 102 preferably results in contact between those structures in the event of exposure to a force that varies from a rearward direction, such as an oblique force caused by bumping lid 104. Advantageously, due to this position of lower extension 126 within notch 128, there is increased stability of lid 104 and reduced likelihood that lid 104 would be displaced in the event of exposure to an oblique force.

At step 390, lid 104 is continued to be forced into housing 102 along guides 116 until lid 104 is closed, wherein storage device is preferably locked with cantilever 106 returned to its open configuration. In preferred methods, the final application of force to move lid 104 into the closed position covering well 114 is accomplished by applying force to front surface 130 of lid 104 or front surface 132 of lower extension 126. In these preferred method, and wherein cantilever 106 is biased to provide sufficient force to return to the open position, once cantilever 106 is inserted beyond crossbar 120, cantilever 106 springs to its resting position and its upward motion is arrested due to the contact between protrusion 118 and crossbar 120. In preferred embodiments, this sudden contact causes a noise, which provides an audible alert to the user that storage device 100 is locked and that lid 104 is in a fully closed position.

Once the lid is closed, the user may decide whether to open the same or another lid. If so, the method proceeds to step 340. If not, the method proceeds to end step 330.

It is to be understood that the implementations described herein are illustrative and that the scope of the present invention is not limited to those specific embodiments; many variations, modifications, additions, and improvements are possible. For example, functionality may be separated or combined in blocks differently in various embodiments of the disclosure or described with different terminology. These and other variations, modifications, additions, and improvements may fall within the scope of the disclosure as defined in the claims that follow.

What is claimed is:

1. A lockable container for holding pills, the lockable container comprising:
a housing defining a plurality of wells, each well of the plurality of wells comprising a guide;
a plurality of lids, each lid of the plurality of lids configured to lock a corresponding well of the plurality of wells in a closed position, each lid comprising a slidable base and a cantilever extending from a top surface of the slidable base, wherein a free end of each cantilever comprises a protrusion extending therefrom, the lid is configured to be slidably coupled to a corresponding guide, and the slidable base comprises a receiver,
wherein each lid further comprises a bottom surface and a lower extension extending below the bottom surface, the lower extension defining at least a portion of the receiver, and
wherein the cantilever is configured to move between a first position and a second position in response to application of an opening force such that the protrusion moves into the receiver to unlock the lid and permit the slidable base to slide relative to the corresponding well, to thereby open the corresponding well.

2. The lockable container of claim 1, wherein the bottom surface of each lid comprises a stopping member.

3. The lockable container of claim 1, wherein each protrusion is configured to engage the housing when the corresponding cantilever is in the first position.

4. The lockable container of claim 1, wherein the housing further comprises a crossbar configured to prevent the lid from sliding along the corresponding guide when the cantilever is in the first position.

5. The lockable container of claim 4, wherein the cantilever is configured to slide under the crossbar when the cantilever is in the second position to permit the lid to be unlocked to open the corresponding well.

6. The lockable container of claim 1, wherein engagement between the protrusion and the housing causes an audible sound when the lid is transitioned to the closed position to indicate that the lid is locked.

7. The lockable container of claim 1, wherein each lower extension comprises a front surface, the front surface extending beyond the housing when the corresponding lid is in the closed position.

8. The lockable container of claim 1, wherein each slidable base comprises a front surface, the front surface extending beyond the housing when the corresponding lid is in the closed position.

9. A lockable container comprising:
a housing defining a well, the well comprising a guide;
a lid configured to lock the well in a closed position, the lid comprising a slidable base and a cantilever extending from a top surface of the slidable base, wherein a free end of the cantilever comprises a protrusion extending therefrom, the lid further configured to be slidably coupled to the guide, and the slidable base comprises a receiver,
wherein the lid further comprises a bottom surface and a lower extension extending below the bottom surface, the lower extension defining at least a portion of the receiver, and
wherein the cantilever is configured to move between a first position and a second position in response to application of an opening force such that the protrusion moves into the receiver to unlock the lid and permit the slidable base to slide relative to the well, to thereby open the well.

10. The lockable container of claim 9, wherein the bottom surface comprises a stopping member.

11. The lockable container of claim 9, wherein the protrusion is configured to engage the housing when the cantilever is in the first position.

12. The lockable container of claim 9, wherein the housing further comprises a crossbar configured to prevent the lid from sliding along the guide when the cantilever is in the first position.

13. The lockable container of claim 12, wherein the cantilever is configured to slide under the crossbar when the cantilever is in the second position to permit the lid to be unlocked to open the well.

14. The lockable container of claim 9, wherein engagement between the protrusion and the housing causes an audible sound when the lid is transitioned to the closed position to indicate that the lid is locked.

15. The lockable container of claim 9, wherein the lower extension comprises a front surface, the front surface extending beyond the housing when the lid is in the closed position.

16. A method of operating a lockable container, the method comprising:
accessing the lockable container comprising a housing and a lid,
wherein the housing defines a well and an opening, the well comprising a guide,
wherein the lid is configured to lock the well in a closed position, the lid comprises a slidable base and a cantilever extending from a top surface of the slidable base, the slidable base comprising a receiver, wherein a free end of the cantilever comprises a protrusion extending therefrom, the lid further configured to be slidably coupled to the guide,
wherein the lid further comprises a bottom surface and a lower extension extending below the bottom surface, the lower extension defining at least a portion of the receiver,
wherein the opening comprises a notch dimensioned to accommodate the lower extension, and
wherein the cantilever is configured to move between a first position and a second position in response to application of an opening force such that the protrusion moves into the receiver to unlock the lid and permit the slidable base to slide relative to the well;
applying the opening force while the lid is in the closed position;
sliding the slidable base in the guide;
moving the lower extension at least partially through the notch; and
displacing the lid sufficiently from the closed position to access the well.

17. The method of claim 16 wherein the lid further comprises a stopping member and the method further comprises causing the stopping member to contact the housing.

18. The method of claim 16 further comprising applying a rearward force to the lid to displace the lid toward the closed position.

19. The method of claim 18 wherein the lid comprises a front surface extending beyond the housing when the lid is in the closed position, and wherein applying the rearward force to the lid to displace the lid toward the closed position comprises applying the rearward force to the front surface of the lid.

20. The method of claim 16 further comprising moving the lid into the closed position and causing the protrusion to contact the housing and make an audible alert.
